(19) United States
(12) Patent Application Publication
(10) Pub. No.: US 2004/0070492 A1
(43) Pub. Date: Apr. 15, 2004

(54) Alarm device for retaining vehicles in a path

(76) Inventor: Reg Huang, Taipei (TW)

Correspondence Address: Reg Huang, 235 Chung-Ho, Box 8-24, Taipei, TW

(21) Appl. No.: 10/270,426

(22) Filed: Oct. 15, 2002

(51) Int. Cl. B60Q 1/00

(52) U.S. Cl. 340/435

(57) ABSTRACT

An alarm device serves for retaining a vehicle in a path. Each of two sides of a vehicle is installed with a respective alarm device. The power supply servers to supply power and is connected to an optical sensor. The optical sensor is installed externally to a vehicle for sensing light reflected from the spacing lines of a road and converts the light signal into current signals The optical sensor generates different currents according to the reflecting light. The signal converter serves to convert current signals into voltage signals. The voltage comparison and amplifying device serves to compare the voltage signals different parts of a road with a threshold value and amplifies the comparing result to the alarm display. The alarm display provides various alarming ways so as to alert the driver that the car has deviated from the path so as to improve the safety in driving.

### BACKGROUND OF THE INVENTION

The present invention relates to vehicle alarm device, and particularly to an alarm device for retaining a vehicle in a path, wherein an alarm display provides various alarming ways so as to alert the driver that the car has deviated from the path so as to improve the safety in driving.

When the drives cannot concentrate his (or her) attention, an accident possibly occurs and thus the safety of the driven and passenger is threatened. Before occurring an accident, it is often that the car is out of the path or the car is near an object not necessary in the driving path. However, these events can be detected by the reflected light from the objects in the driving path. Since the variation of the environment must induce the change of the reflecting light. Thereby, if we compares the reflect right with some other reference value, an abnormality can be detected.

### SUMMARY OF THE INVENTION

Accordingly, the primary object of the present invention is to provide an alarm device for retaining a vehicle in a path. Each of two sides of a vehicle is installed with a respective alarm device. The power supply servers to supply power and is connected to an optical sensor. The optical sensor is installed externally to a vehicle for sensing light reflected from the spacing lines of a road and converts the light signal into current signals The optical sensor generates different currents according to the reflecting light and the current is inputted to the signal converter. The signal converter serves to convert current signals into voltage signals. The voltage comparison and amplifying device serves to compare the voltage signals induced from the reflected light from different parts of a road and amplifies the comparing result to the alarm display. The alarm display provides various alarming ways so as to alert the driver that the car has deviated from the path so as to improve the safety in driving.

The various objects and advantages of the present invention will be more readily understood from the following detailed description when read in conjunction with the appended drawing.

### BRIEF DESCRIPTION OF THE DRAWINGS

FIG. 1 is a schematic view of the present invention.

FIG. 2 is a structural schematic view of the present invention.

FIG. 3 is a schematic view showing one embodiment of the present invention.

### DETAILED DESCRIPTION OF THE PREFERRED EMBODIMENTS

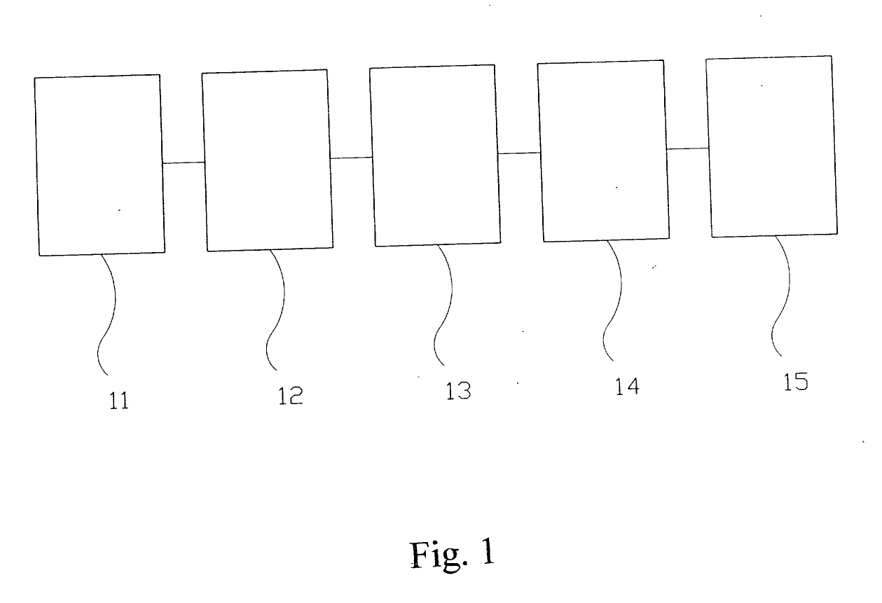

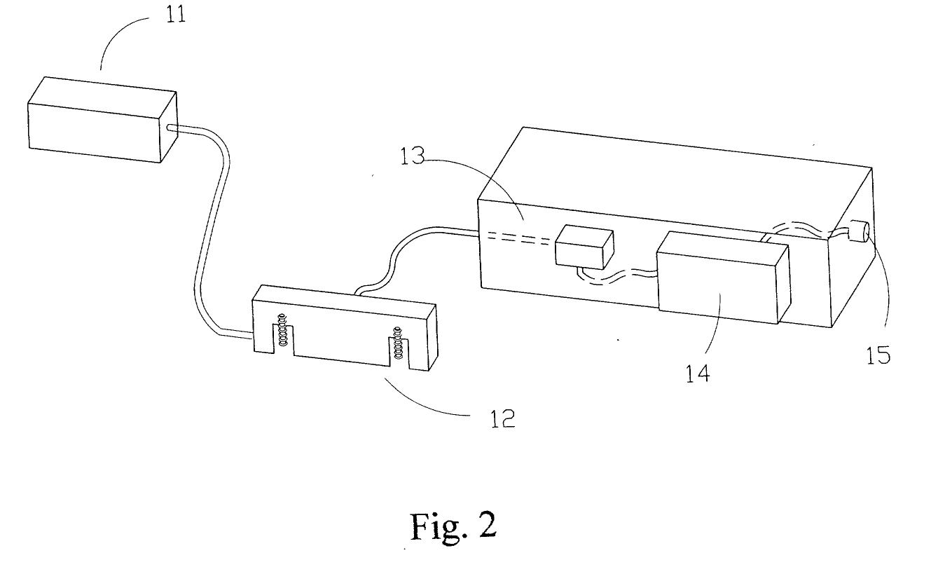

Referring to FIGS. 1, 2 and 3, the alarm device for retaining a vehicle in a path of the present invention is illustrated. In the present invention, each of two sides of a vehicle 2 is installed with a respective alarm device 1. The alarm device 1 is installed with a power supply 11, an optical sensor 12, a signal converter 13, a voltage comparison and amplifying device 14, and an alarm display 15. The power supply 11 servers to supply power to the alarm device of the present invention and is connected to an optical sensor 12.

The optical sensor 12 is installed externally to a vehicle for sensing light reflected from the spacing lines 21 of a road and converts the light signal into current signals. Generally, light reflecting from the spacing lines is dense than the parts 22 of the road having no painting with spacing lines. Thereby, the optical sensor 12 generates different currents according to the reflecting light. In the present invention, the optical sensor 12 may be one of photoelectric crystals, optic diodes, or other optic sensing elements.

The signal converter 13 serves to convert current signals into voltage signals.

The voltage comparison and amplifying device 14 serves to compare the voltage signals of the spacing lines or the parts of no spacing lines so as to know whether the car is driven along a correct path and then amplifies the comparing result to the alarm display 15.

The alarm display 15 provides various alarming ways (for example, alarm voices, etc.) so as to alert the driver that the car has deviated from the path so as to improve the safety in driving.

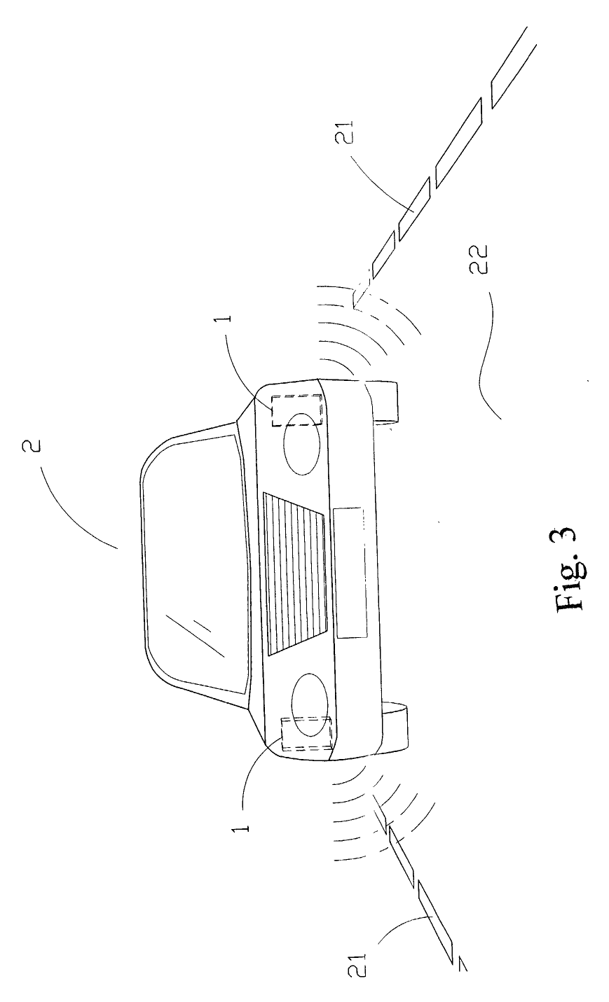

Referring to FIG. 3, when the driver drives a car 2. Each of two sides of the vehicle 2 is installed with a respective alarm device 1. The power supply 11 of the alarm device 1 supply power to the alarm device 1 and thus the optical sensor 12 senses the light reflected from the road. Since the light reflected from the spacing lines of a road are larger than the other parts 22 of the road. Thereby, the optical sensor 12 can sense different current values due to the difference of the reflecting light, and the light signals inputted the optical sensor 12 are converted into current. The current is inputted to the signal converter 13 so as to be converted into voltage signal. Then the signal is further transferred to the voltage comparison and amplifying device 14 for comparison and amplifying. Then the comparison result is sent to the alarm display 15 for alerting the user whether the car is deviated from the driving path. Thus, traffic accident can be avoided.

The advantage of the present invention is:

1. Suitable to various cars.

2. Convenient in installation.

3. Safe and thus accident is avoided.

4. Competitive.

5. Useful

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An alarm device for retaining a vehicle in a path; each of two sides of a vehicle being installed with a respective alarm device; the alarm device being installed with a power supply, an optical sensor, a signal converter, a voltage comparison and amplifying device, and an alarm display; wherein
the power supply servers to supply power and is connected to an optical sensor;
the optical sensor is installed externally to a vehicle for sensing light reflected from the spacing lines of a road and converts the light signal into current signals; the optical sensor generates different currents according to the reflecting light and the current is inputted to the signal converter;
the signal converter is connected to the optical sensor and serves to convert current signals into voltage signals;
the voltage comparison and amplifying device receives the voltage signals from the signal converter and serves to compare the voltage signals different parts of a road so as to know whether the vehicle is driven in a correct path and amplifies the comparing result to the alarm display; and
the alarm display provides various alarming ways so as to alert the driver that the car has deviated from the path so as to improve the safety in driving.

2. The alarm device for retaining a vehicle in a path as claim in claim 1, wherein the optical sensor is selected from one of photoelectric crystals, optic diodes, and optic sensing elements.

3. The alarm device for retaining a vehicle in a path as claim in claim 1, wherein the alarm display displays signals by various ways.
